(19) United States
(12) Patent Application Publication
(10) Pub. No.: US 2006/0286542 A1
(43) Pub. Date: Dec. 21, 2006

(54) Entertainment system and method useful for recruiting and training associates

(76) Inventor: Clay Stevens, Dayton, WA (US)

Correspondence Address: UTAH VALLEY PATENT SERVICES, LLC, 846 S. 1350 E., PROVO, UT, 84606, US

(21) Appl. No.: 11/372,781

(22) Filed: Mar. 10, 2006

Related U.S. Application Data
(63) Continuation-in-part of application No. 11/140,168, filed on May 27, 2005.

(51) Int. Cl. G09B 25/00

(52) U.S. Cl. 434/365

(57) ABSTRACT

An activity dispenser provides activity descriptors drawn from randomly selected activity categories interspersed with activity descriptors drawn from participant selected activity categories. Each activity descriptor includes an activity description and an activity consequence. Certain activity descriptions may specify a task which the participant is required to perform a task in order to receive the activity consequence. The activity descriptors enable a participant to visualize and/or perform the described activity and vicariously experience the consequence of the behavior or activity resulting in entertaining yet effective training for participating in an actual enterprise.

### RELATED APPLICATIONS

This application is a continuation-in-part of U.S. patent application Ser. No. 11/140,168 entitled “APPARATUS AND METHOD FOR DEVELOPING A GAME FROM SELECTABLE CONTENT” and filed on Jul. 27^{th} 2005 for Clay Stevens which is incorporated herein by reference.

### BACKGROUND OF THE INVENTION

1. Field of the Invention

This invention relates generally to entertainment devices, methods, and systems and more particularly relates to systems and methods for recruiting and training associates in an amusing manner.

2. Description of the Related Art

Recruiting, training, and retaining personnel is often a risky and expensive proposition for businesses and organizations. Individuals that appear promising may be unprepared for particular tasks and challenges. Personal aptitudes, preferences, and beliefs may limit the effectiveness of particular individuals. What is needed is a system and method to recruit, train and retain potential associates that provides meaningful experiences as well as insight into the potential challenges and opportunities of engaging in a particular enterprise.

### SUMMARY OF THE INVENTION

The present invention has been developed in response to the present state of the art, and in particular, in response to the problems and needs in the art that have not yet been fully solved by currently available recruiting and training systems. Accordingly, the present invention has been developed to provide an entertainment system and method useful for recruiting and training associates that overcome many or all of the above-discussed shortcomings in the art.

In one aspect of the present invention, a system for training participants includes a number of activity descriptors assigned to various activity categories, and an activity dispenser that provides activity descriptors drawn from randomly selected activity categories interspersed with activity descriptors drawn from participant selected activity categories. Each activity descriptor includes an activity description and an activity consequence. Certain activity descriptions may specify a task which the participant is required to perform in order to receive the activity consequence.

The activity descriptors present information or content to the participants. Examples of activity descriptors include playing cards, multimedia content, and software data structures. The activity dispenser presents the activity descriptors or the information contained therein to the participants. Examples of the activity dispenser include a playing board, a software module, and a media player. In one embodiment, the activity dispenser adjusts a category frequency according to predetermined achievement criteria. Adjusting a category frequency facilitates tailoring the experience for various levels of competence or training.

The activity description may include one or more one activity qualifiers that must be achieved to receive the activity consequence. The activity consequence may also be dependent on a performance rating provided by another participant. Examples of an activity consequence include a change in a personal effectiveness metric, a change in resources, a change in customers, a change in associates, team, group, or colleagues, a change in sales, a change in profit margin, a change in rank, and a change in compensation.

The system may also include a participant evaluation module that facilitates tracking various metrics such as a personal effectiveness metric and a current compensation. The current compensation may be based on a variety of factors such as organizational size, total revenue, revenue balance, sales conversion rate, profit margin, customer satisfaction, team responsiveness, and personal effectiveness. In one particular embodiment, the activity categories include personal improvement (e.g. skills, knowledge, attitudes, and beliefs), team development, organizational development, practice, prospecting, sales, marketing (e.g. advertising, publicity, and brand development), and networking.

The present invention facilitates recruiting and training associates in a low-key entertaining manner. It should be noted that references to features, advantages, or similar language within this specification does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The aforementioned features and advantages of the present invention will become more fully apparent from the following description and appended claims, or may be learned by the practice of the invention as set forth hereinafter.

### BRIEF DESCRIPTION OF THE DRAWINGS

To enable the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting one embodiment of a training system of the present invention;

FIG. 2 is a flow chart diagram depicting one embodiment of a training method of the present invention;

FIG. 3 is a layout diagram depicting a particular example of some elements of the training system of FIG. 1 namely a network marketing board game of the present invention;

FIGS. 4a-4d are layout diagrams depicting particular examples of activity descriptors of the present invention; and

FIGS. 5a and 5b are layout diagrams depicting a particular example of a participant evaluation module of the present invention.

### DETAILED DESCRIPTION OF THE INVENTION

Some of the functional units described in this specification have been explicitly labeled as modules, (while others are assumed to be modules) in order to emphasize their implementation independence. For example, a module may be implemented as a hardware circuit comprising custom VLSI circuits, MEMS devices, or gate arrays, off-the-shelf semiconductors such as logic chips, transistors, or other discrete electrical or mechanical components. A module may also be implemented in programmable hardware devices or systems such as field programmable gate arrays, programmable array logic, and programmable logic devices.

Modules may be implemented in various media such as printed material or digital media incorporating various forms of content such as audio, video, text, and graphics. Modules may also be implemented in software for execution by various types of processors such as embedded processing units, microcontrollers, or the like. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

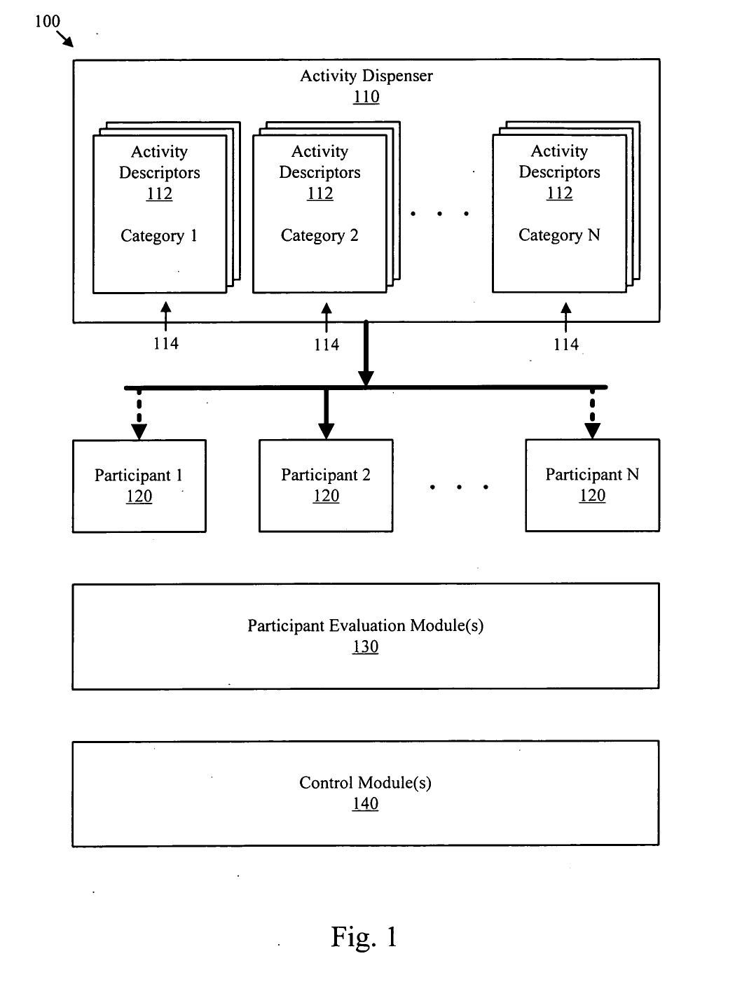

FIG. 1 is a block diagram depicting one embodiment of a training system 100 of the present invention. As depicted, the training system 100 includes an activity dispenser 110, one or more participants 120, and one or more participant evaluation modules 130, and may optionally include one or more control modules 140. The training system 100 facilitates training participants such as associates in a non-threatening game-like environment.

The activity dispenser 110 provides activity descriptors 112 to the participants 120. The activity dispenser 110 may be a software equipped computer, a media player, a game board, or the like. The activity descriptors 112 describe an activity or behavior and a resulting consequence of engaging in that activity or behavior. The activity descriptors 112 may be embodied as printed cards, digital content, software data structures, or similar information delivery means.

In certain embodiments, the participants 120 are assigned specific roles or characters to assume during the activity sessions. The participants 120 may receive or retrieve the activity descriptors 112 in round robin order, verbalize the associated content, and possibly perform a described task. In certain instances, participants awaiting their turn may be required to interact with, and/or judge a performance of, the participant engaged in the described activity.

Some activity descriptors 112 may be purely educational and help the participants to visual the activity and associated consequences without actually engaging in the activity. Other activity descriptors 112 may describe a task such as role playing that the participant must complete to receive the associated consequence. Receiving the activity consequence may be dependent on a performance rating provided by another participant.

Certain activity descriptors 112 may also include one or more activity qualifications (not shown), The activity qualifications detail particular qualifications that the participant must achieve in order to engage in the activity and/or receive the associated consequence. Specifying one or more activity qualifications communicates to the participants particular achievements, resources, and behaviors that facilitate achieving desirable consequences and motivates to the participants to become fully qualified to engage in such activities and behaviors.

The activity descriptors 112 may be logically organized into various categories 114 to facilitate self-directed training. In the depicted embodiment, the activity dispenser 110 intersperses activity descriptors drawn from participant selected activity categories with activity descriptors drawn from randomly selected activity categories. Interspersing activity descriptors selected from participant selected activity categories with randomly selected activity categories increases personal growth by showing the power of personal choice as well as the value of adaptability to a variety of experiences.

The participant evaluation modules 130 may receive information provided by each participant and track various metrics associated with each participant such as a personal effectiveness level, a skill level, a compensation level, and the like. The optional control module or modules 140 may control the flow of one or more activity sessions conducted in conjunction with the training system 100. In some embodiments, the control modules 140 communicate instructions to the participants 120 and monitor each activity session. The functionality of the control module 140 may be performed partially or wholly by a designated person such as a moderator who may also be a participant 120. In some embodiments, the control module 110 may not be necessary and may be omitted.

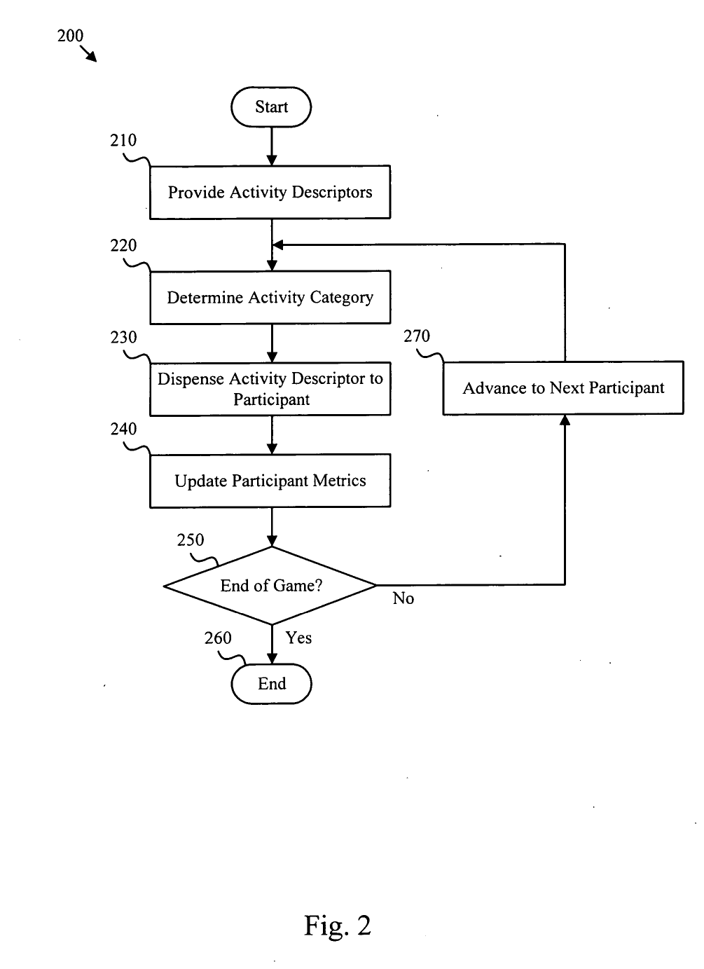

FIG. 2 is a flow chart diagram depicting one embodiment of a training method 200 of the present invention. As depicted, the training method 200 includes providing 210 one or more activity descriptors, determining 220 a current activity category, dispensing 230 an activity descriptor, updating 240 one or more participant metrics, and advancing 270 to a next participant. The training method 200 may be conducted in conjunction with the training system 100 or the like.

Providing 210 one or more activity descriptors may include organizing activity descriptors into various logical categories. Determining 220 a current activity category may include randomly selecting an activity category or allowing a user to select a particular activity category. Dispensing 230 an activity descriptor may include presenting content associated with the activity descriptor. In one embodiment, dispensing 230 an activity descriptor involves directing a user to a particular dispensing area on a game board. In another embodiment, dispensing 230 an activity descriptor involves displaying content on an electronic display.

Updating 240 one or more participant metrics may include computing and/or tracking particular metrics or scores associated with a participant such as personal effectiveness, available resources, number of customers, number of associates, sales, profit margin, rank, and compensation. In one embodiment, compensation is based on a variety of factors such as organizational size, total revenue, revenue balance, sales conversion rate, profit margin, customer satisfaction, team responsiveness, and personal effectiveness.

Subsequent to updating 240 one or more participant metrics, the method may continue by testing 250 if the game has ended. If the game has not ended, the method continues by advancing 270 to the next participant. If the game has ended, the method ends 260.

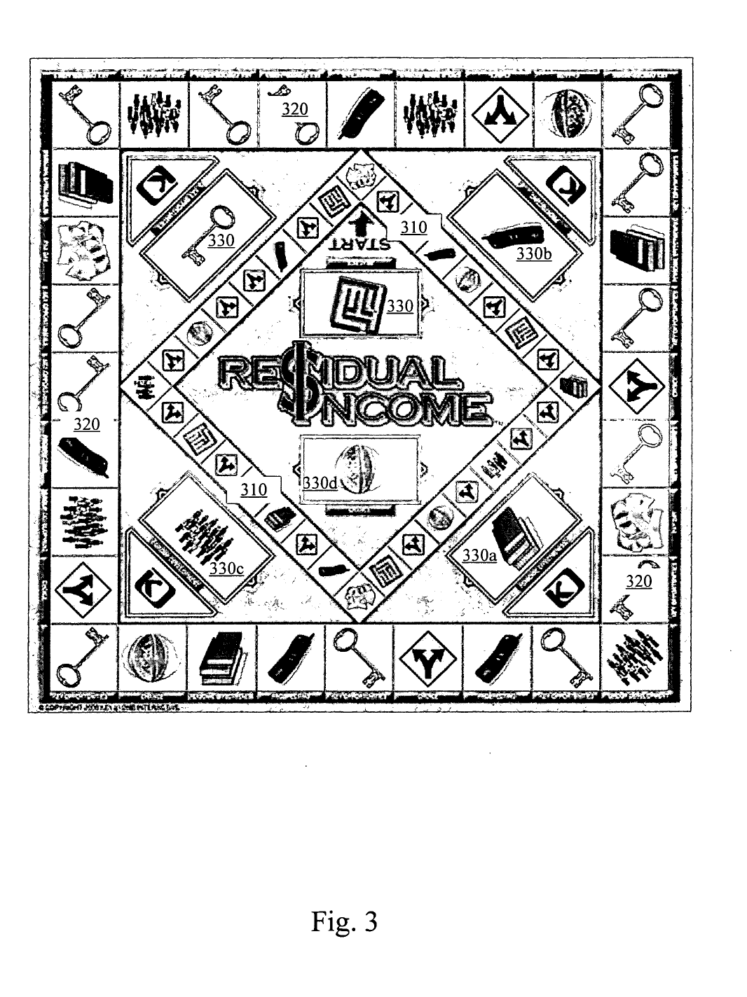

FIG. 3 is a layout diagram depicting a particular example of some elements of the training system of FIG. 1 embodied as a network marketing board game 300. As depicted, the network marketing board game 300 includes an inner track 310, an outer track 320, and a number of dispensing areas 330. The network marketing board game 300 is one example of the activity dispenser 110 depicted in FIG. 1.

Each participant 120 may move tokens (not shown) around the inner track 310 until a specified level of competency (or similar metric) is achieved. Participants who achieve the specified level of competency may proceed to the outer track 320. Other embodiments may use more than 2 tracks in order to adjust the experiences of participants of particular levels of training or effectiveness.

In the depicted embodiment, each position within the inner track 310 and outer track 320 contains a graphic or symbol that identifies the current options for the participant. For example, some symbols indicate that the participant must engage in an activity from a specific activity category corresponding to a particular dispensing area 330. Other symbols indicate that the participant is free to select an activity category and draw a card from participant selected dispensing area.

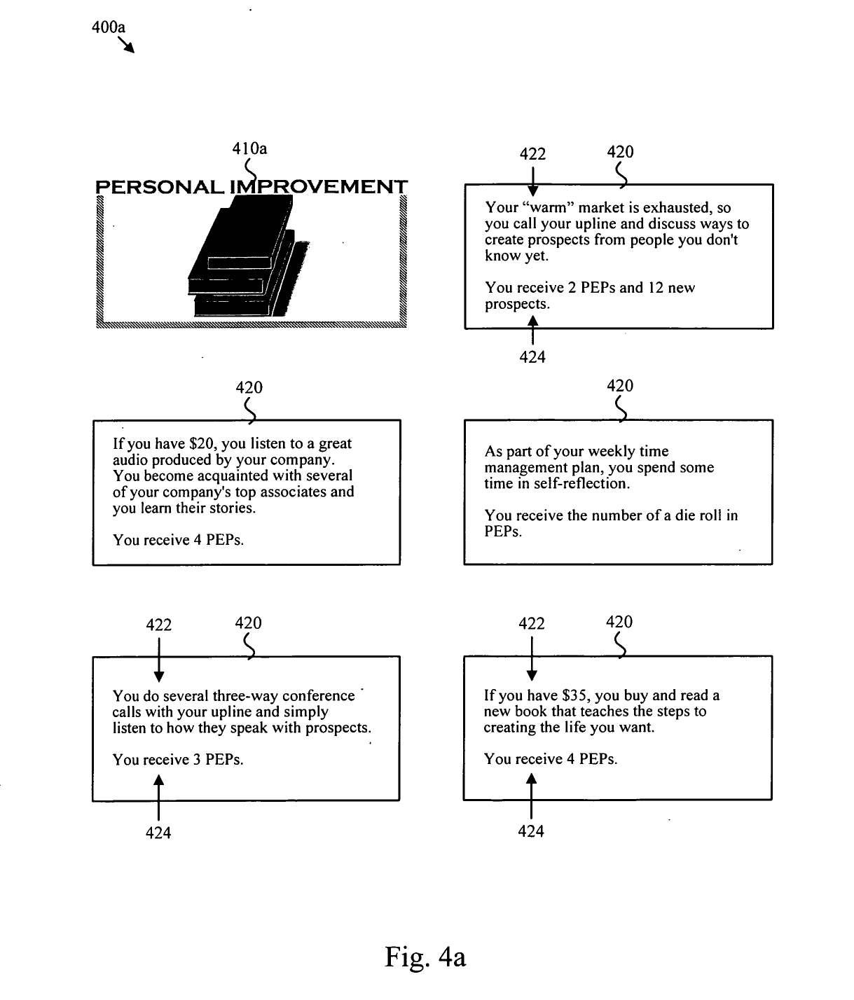

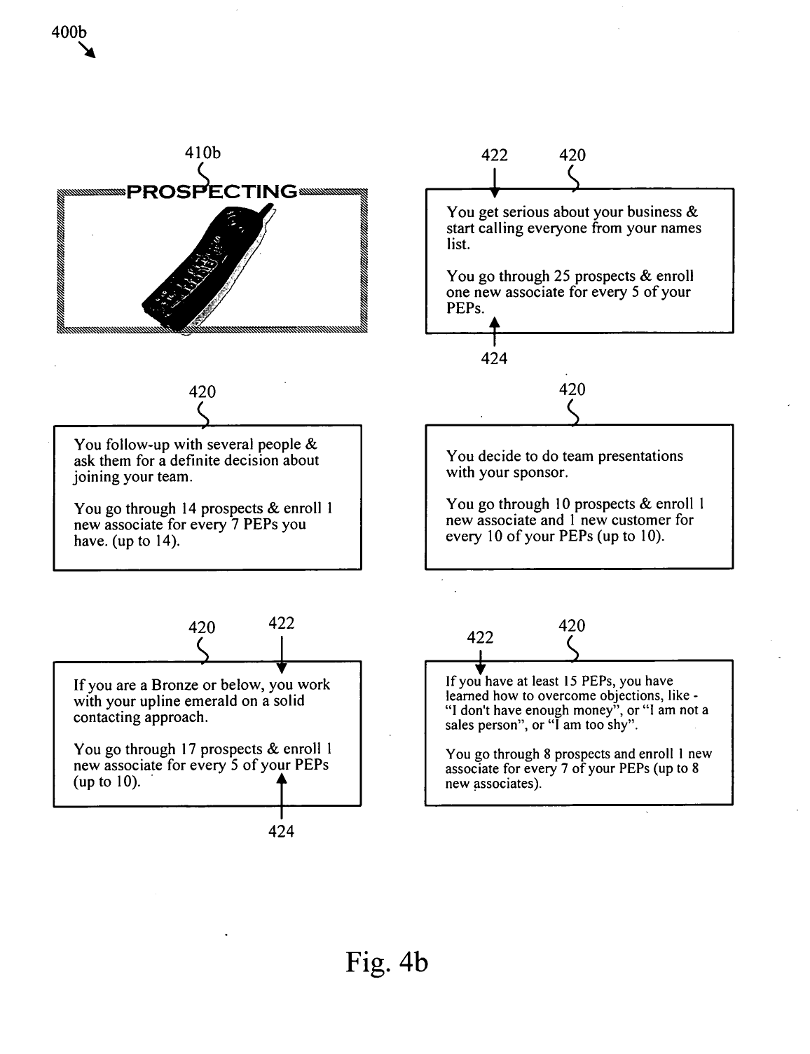

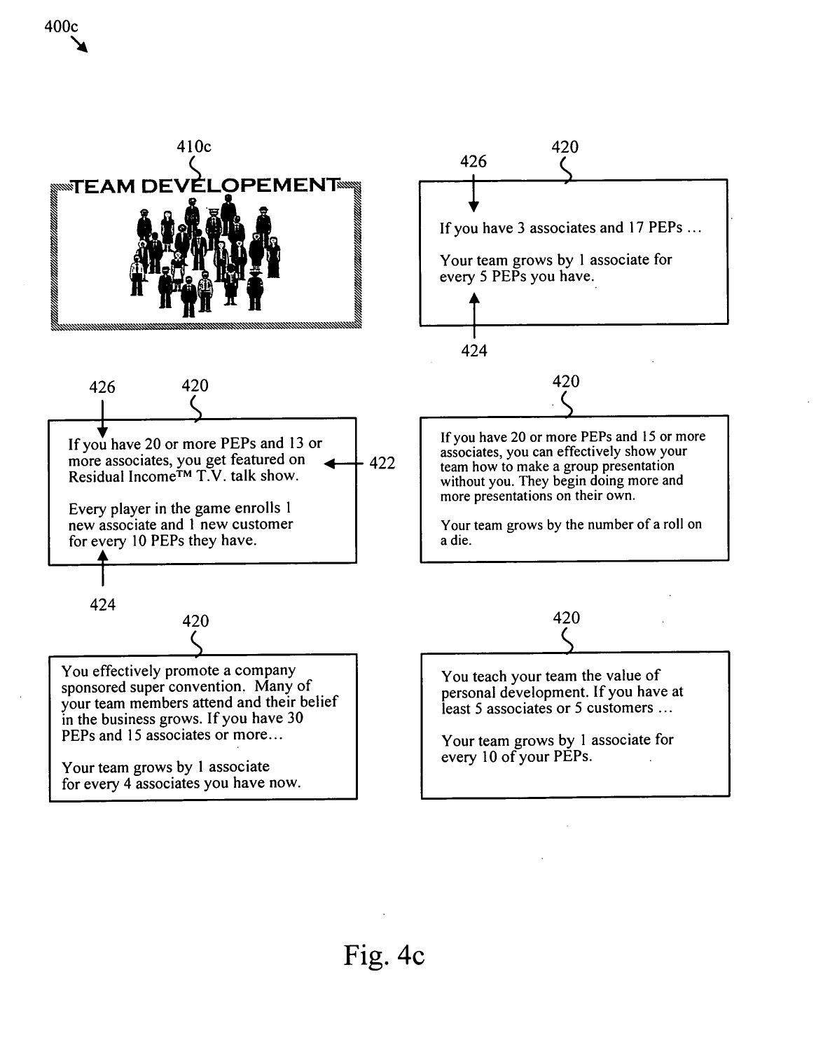

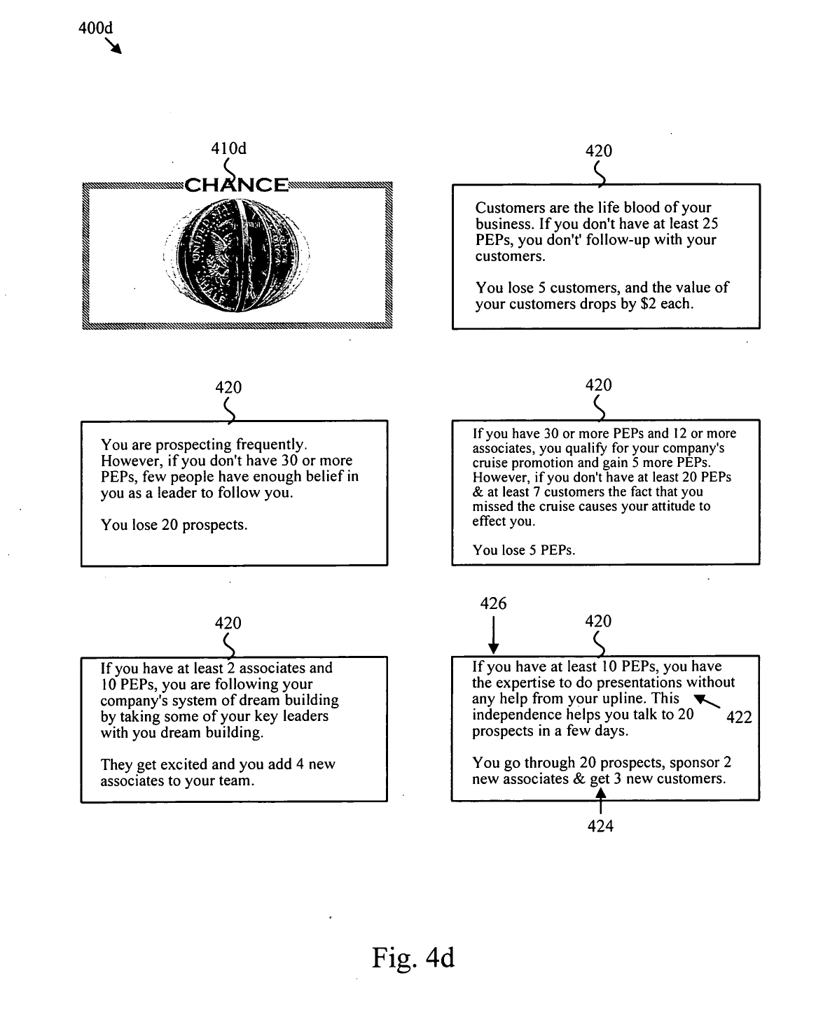

FIGS. 4a-4d are layout diagrams depicting particular examples of activity descriptors 420 corresponding to particular activity categories and symbols shown in FIG. 3. FIG. 4a depicts activity descriptors 420 corresponding to a ‘personal effectiveness’ activity category and a dispensing area 330a. FIG. 4b depicts activity descriptors 420 corresponding to a ‘prospecting’ activity category and a dispensing area 330b. Similarly, FIG. 4c depicts activity descriptors 420 corresponding to a ‘team development’ activity category and a dispensing area 330c while FIG. 4d depicts activity descriptors 420 corresponding to a ‘chance’ activity category and a dispensing area 330d.

The activity descriptors 420 include an activity description 422 and an activity consequence 424. The activity description 422 may also include an activity qualifier 426 that must be achieved to receive the activity consequence 424. In some cases the activity description 422 describes a particular scenario but does not require performing an actual task. In other cases, the activity description 422 describes an exercise or task that must be performed to reap the activity consequence 424.

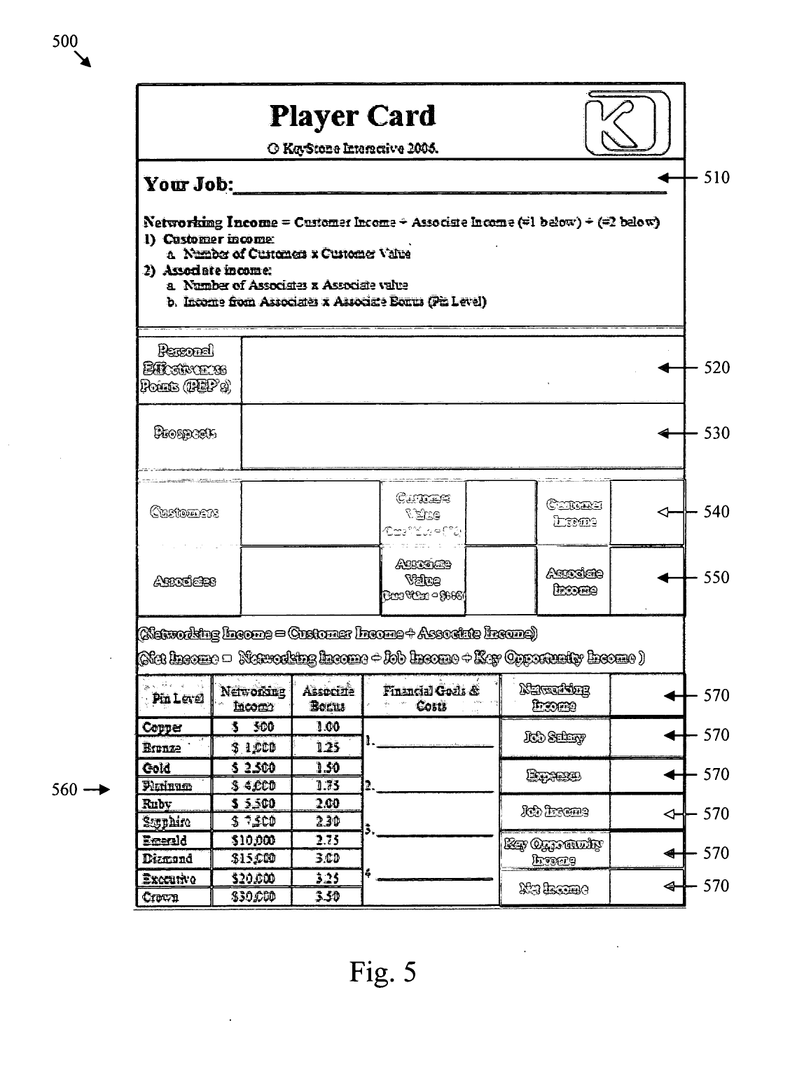

FIG. 5 is a layout diagram depicting a particular example of a participant evaluation module 500 of the present invention. As depicted, the participant evaluation module 500 includes a job title 510, a personal effectiveness metric 520, a prospect list 530, a set of customer metrics 540, a set of associate metrics 550, a networking rank 560, and a set of income metrics 570. The participant evaluation module 500 is useful for tracking various metrics for a participant and is one example of the participant evaluation module 130 depicted in FIG. 1. By tracking various metrics the participants are able to experience the effect of various activities, attitudes, and behaviors and learn key factors for success in an actual real world enterprise.

The present invention facilitates recruiting and training associates in an entertaining manner. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for training participants, the system comprising:
a plurality of activity descriptors, each activity descriptor thereof comprising an activity description and an activity consequence, each activity descriptor assigned to an activity category; and
an activity dispenser configured to provide activity descriptors drawn from randomly selected activity categories interspersed with activity descriptors drawn from participant selected activity categories.

2. The system of claim 1, wherein the participant is required to perform a task specified in the activity description to receive the activity consequence.

3. The system of claim 2, wherein the activity consequence is dependent on a performance rating provided by another participant.

4. The system of claim 1, wherein the activity consequence is selected from the group consisting of a change in a personal effectiveness metric, a change in resources, a change in customers, a change in associates, a change in sales, a change in profit margin, a change in rank, and a change in compensation.

5. The system of claim 1, wherein selected activity descriptors further comprise at least one activity qualifier.

6. The system of claim 1, wherein the activity consequence is dependent on complying with the at least one activity qualifier.

7. The system of claim 1, further comprising a participant evaluation module configured to track a personal effectiveness metric for at least one participant.

8. The system of claim 1, wherein the participant evaluation module is further configured to track a current compensation for the at least one participant.

9. The system of claim 1, wherein the current compensation is based on factors selected from organizational size, total revenue, revenue balance, sales conversion rate, profit margin, customer satisfaction, team responsiveness, and personal effectiveness.

10. The system of claim 1, wherein the activity dispenser is further configured to adjust a category frequency according to predetermined achievement criteria.

11. The system of claim 1, wherein the activity categories are selected from the group consisting of personal improvement, team development, organizational development, practice, prospecting, sales, marketing, and networking.

12. The system of claim 1, wherein the activity descriptors comprise means selected from the group consisting of playing cards, multimedia content, and software data structures.

13. The system of claim 1, wherein the activity dispenser comprises means selected from the group consisting of a playing board, a software module, and a media player.

14. The system of claim 1, wherein compensation is based on factors selected from organizational size, total revenue, revenue balance, sales conversion rate, profit margin, customer satisfaction, team responsiveness, personal effectiveness.

15. A method for training participants, the method comprising:
providing a plurality of activity descriptors, each activity descriptor thereof comprising an activity description and an activity consequence, each activity descriptor assigned to an activity category; and
providing to at least one participant activity descriptors drawn from randomly selected activity categories interspersed with activity descriptors drawn from participant selected activity categories.

16. The method of claim 15, further comprising requiring a participant to perform a task specified in the activity description in order to receive the activity consequence.

17. The method of claim 16, wherein receiving the activity consequence is dependent on a performance rating provided by another participant.

18. The method of claim 15, wherein the activity consequence is selected from the group consisting of a change in a personal effectiveness metric, a change in resources, a change in customers, a change in associates, a change in sales, a change in profit margin, a change in rank, and a change in compensation.

19. The method of claim 15, wherein compensation to a participant is based on factors selected from organizational size, total revenue, revenue balance, sales conversion rate, profit margin, customer satisfaction, team responsiveness, personal effectiveness.

20. The method of claim 15, wherein selected activity descriptors further comprise at least one activity qualifier.

21. The method of claim 15, wherein the activity consequence is dependent on complying with the at least one qualification.

22. The method of claim 15, further comprising tracking a personal effectiveness metric for at least one participant.

23. The method of claim 15, further comprising tacking a compensation level for the at least one participant.

24. The method of claim 15, further comprising adjusting a category frequency in response to a participant meeting predetermined achievement criteria.

25. The method of claim 15, wherein the activity categories are selected from the group consisting of personal improvement, team development, organizational development, practice, prospecting, sales, marketing, and networking.
